(19) United States
(12) Patent Application Publication
(10) Pub. No.: US 2025/0276871 A1
(43) Pub. Date: Sep. 4, 2025

(54) METHOD AND SYSTEM FOR WEAR MONITORING OF STEEL WIRE ROPES

(71) Applicant: Prysmian S.p.A., Milano (IT)

(72) Inventor: Antonio Di Stefano, Palermo (IT)

(21) Appl. No.: 19/067,391

(22) Filed: Feb. 28, 2025

(30) Foreign Application Priority Data
Mar. 4, 2024 (IT) 102024000004738

(51) Int. Cl. B66B 5/00; G01N 27/04

(52) U.S. Cl. CPC B66B 5/0018; G01N 27/041

(57) ABSTRACT

In a method for monitoring wear of a steel wire rope including a plurality of steel wires, the method can include, at a first test, generating a current at a base frequency and determining a first base value of an electrical parameter, at the first test, generating a current at a test frequency higher than the base frequency and determining a first test value of the parameter, and, at a second test following the first test, generating a current at the base frequency and determining a second base value, and generating a current at the test frequency and determining a second test value. The method can further include determining a first coefficient based on the first base and test values, determining a second coefficient based on the second base and test values, and determining, using the first coefficient and the second coefficient, a wear level of the steel wire rope.

### CROSS-REFERENCE TO RELATED APPLICATIONS

This application claims priority to and the benefit of Italian Patent Application No. 102024000004738 filed on Mar. 4, 2024, the entire contents of which are incorporated herein by reference.

### TECHNICAL FIELD

The present disclosure relates to the field of steel wire ropes used in, e.g., elevators, cranes, and, in general, transportation systems.

### BACKGROUND

As known, elevator systems, as well as cranes and, in general, transportation systems may utilize steel wire ropes (possibly arranged into belts) to move and hold the car or basket. These applications require the steel wire ropes to be accurately and reliably monitored as to their wear conditions. The monitoring of the steel wire ropes, in particular, needs to be continuous and automated to guarantee the safety of the transportation system.

Currently, the condition of steel wire ropes is assessed by spot monitoring (i.e. from time to time) and by employing manual technologies and human experts. The assessment of the ropes' condition is in fact made by using, mainly, visual inspection or magneto-inductive technologies.

However, in some cases, these approaches cannot be used at all or are not able to assess the wear level of a steel wire rope along its entire length. Specifically, visual inspection cannot be carried out for jacketed ropes/belts (where ropes or belts are embedded in an elastomeric medium), and magneto-inductive methods cannot reach and monitor the rope or belt ends, due to the volume and structure of the fastening fixtures. Both these problems are particularly critical when monitoring the conditions of an elevator's ropes or belts, where both criticalities are often encountered.

Alternative techniques have been proposed to overcome these limitations and automate the monitoring operations, such as techniques based on the measurement of the rope electrical resistance or impedance. Indeed, as known, the rope electrical resistance or impedance is influenced by the rope's wear level, which reduces the rope's diameter, and hence the resistance or impedance measurement may give an indication of the rope's condition.

European patent number EP 2958844 B1 discloses a method of fault detection of a belt or rope, which includes connecting a fault detection unit to at least a portion of a belt or rope including a plurality of wires arranged in a plurality of strands and/or cords. At least a portion of the belt or rope is subjected to an AC voltage of high frequency range and an electrical impedance of the portion of the belt or rope is measured via the fault detection unit. Using at least the measured electrical impedance of the portion of the belt or rope, a fault condition of the belt or rope is determined.

U.S. Pat. No. 7,653,506 B2 discloses a system and method for monitoring the health of a support structure for an elevator based on an electrical characteristic, such as resistance, of the support structure and not the temperature of the structure. The resistance of a virgin support structure under the same temperature conditions as the support structure being monitored is calculated and subtracted from the measured resistance of the monitored support structure. The resistance value of the virgin support structure and the monitored support structure may be translated to a reference temperature to simplify calculations and monitoring of the support structure.

U.S. Pat. No. 8,813,918 B2 discloses an elevator support monitoring device in an elevator system and a method for monitoring an elevator support characterizing property, preferably an electrical resistance, of the elevator support or of a tension support of the elevator support for a sudden change in the characterizing property. A state of the elevator support is determined by evaluating several consecutive, sudden changes in the characterizing property.

### SUMMARY

The present disclosure relates to the field of steel wire ropes used in, e.g., elevators, cranes, and, in general, transportation systems. In particular embodiments, it relates to a method for monitoring the wear of steel wire ropes. In particular embodiments, it relates to a system implementing the method for the wear monitoring of steel wire ropes and to an elevator system including such system.

According to an embodiment of the present disclosure, a method for monitoring wear of a steel wire rope, where the steel wire rope can include a plurality of steel wires, can include:
at a first time:
   a) generating a current at a base frequency and determining a first base value of an electrical parameter of the steel wire rope indicating an opposition of the steel wire rope to the passage of the current;
   b) generating a current at a test frequency higher than the base frequency and determining a first test value of the electrical parameter of the steel wire rope indicating an opposition of the steel wire rope to the passage of the current;
and, at a second time following the first time:
   c) generating a current at the base frequency and determining a second base value of the electrical parameter of the steel wire rope;
   d) generating a current at the test frequency and determining a second test value of the electrical parameter of the steel wire rope; and
the method further comprising:
   e) determining a first coefficient based on the first base value and the first test value of the electrical parameter of the steel wire rope;
   f) determining a second coefficient based on the second base value and the second test value of the electrical parameter of the steel wire rope; and
   g) determining, using the first coefficient and the second coefficient, a wear level of the steel wire rope.

According to an embodiment of the present disclosure, the electrical parameter can be an impedance or a resistance of the steel wire rope. In particular, according to many embodiments of the method, the electrical parameter can be the resistance of the steel wire rope.

According to an embodiment of the present disclosure, the first coefficient can be a ratio between the first test value and the first base value of the electrical parameter and the second coefficient can be a ratio between the second test value and the second base value of the electrical parameter.

According to an embodiment of the present disclosure, the ratio between the test frequency and the base frequency is greater than 1.1.

According to an embodiment of the present disclosure, the base frequency and the test frequency can be fixed frequencies. According to other embodiments, the base frequency can be a fixed frequency and the test frequency can be selected in such a way that the ratio has a fixed value.

According to an embodiment of the present disclosure, the method can further include: providing a set of test frequencies including a number, N, of test frequencies, N being an integer greater than 1, where each test frequency is higher than the base frequency; at the first time, for each test frequency comprised in the set of test frequencies, performing step b); at the second time, for each test frequency comprised in the set of test frequencies, performing step d); determining, for each test frequency comprised in the set of test frequencies, a respective first coefficient based on the first base value and a respective first test value of the electrical parameter of the steel wire rope and a respective second coefficient based on the second base value and a respective second test value of the electrical parameter of the steel wire rope; and determining, using the first coefficients and the second coefficients, a wear level of the steel wire rope.

The ratio between each test frequency and the base frequency may be greater than 1.1.

According to an embodiment of the present disclosure, each of said determining the first base value, determining the first test value, determining the second base value and determining the second test value of the electrical parameter can include: acquiring a voltage across the steel wire rope; providing an in-phase component of the voltage by multiplying the voltage by the current and integrating over a measurement interval; providing a quadrature component of the voltage by multiplying the voltage by a 90° phase-shifted version of the current and integrating over the measurement interval; providing an amplitude of the voltage based on the in-phase component and the quadrature component of the voltage; and computing the impedance or resistance as a ratio between the amplitude of the voltage and an amplitude of the current.

According to an embodiment of the present disclosure, step g) can include computing a difference between the first coefficient and the second coefficient and, based on the difference, determining whether a variation within the structure of the steel wire rope has occurred between the second time and the first time.

According to an embodiment of the present disclosure, determining a wear level of the steel wire rope can include mapping the difference to the wear level by means of any one of: an analytic function, a look-up table, a machine learning algorithm, or any combination thereof.

According to an embodiment of the present disclosure, the wear level can indicate a residual load of the steel wire rope.

The base frequency may be selected between 0 Hz and 1 kHz. According to an embodiment of the present disclosure, the base frequency can be the DC frequency (o Hz). According to other embodiments, the base frequency can be an AC frequency that may be selected between 10 Hz and 1 kHz.

According to an embodiment of the present disclosure, a system for monitoring the wear of a steel wire rope can include: a processing unit; and a current generator, where the current generator is configured to generate a current at a base frequency and to generate a current at a test frequency higher than the base frequency, where the processing unit is configured to determine a base value of an electrical parameter of the steel wire rope indicating an opposition of the steel wire rope to the passage of the current at the base frequency, and a test value of the electrical parameter indicating an opposition of the steel wire rope to the passage of the current at the test frequency, and determine a coefficient based on the base value and the test value of the electrical parameter of the steel wire rope, and where the processing unit is further configured to determine a wear level of the steel wire rope using the coefficient as determined at a first time and the coefficient as determined at a second time following the first time.

According to an embodiment of the present disclosure, an elevator system can include a steel wire rope and a monitoring system for monitoring the wear of the steel wire rope as set forth above.

According to an embodiment of the present disclosure, the elevator system can include a belt including a plurality of steel wire ropes, where at least two steel wire ropes are electrically connected in series with each other and electrically connected to the monitoring system.

### BRIEF DESCRIPTION OF THE DRAWINGS

The present disclosure will become clearer from the following detailed description, given by way of example and not necessarily of limitation, to be read with reference to the accompanying drawings, wherein:

FIG. 1 schematically shows an example elevator system;

FIG. 2 is a block scheme of a system for wear monitoring of steel wire ropes according to an embodiment of the present disclosure;

FIG. 3 is a flowchart illustrating steps of a method for wear monitoring of steel wire ropes according to an embodiment of the present disclosure;

FIG. 4 is a flowchart illustrating further steps of a method for wear monitoring of steel wire ropes according to an embodiment of the present disclosure; and

FIG. 5 shows a graph correlating a resistance of an example steel wire rope with a residual load thereof.

### DETAILED DESCRIPTION OF ILLUSTRATIVE EMBODIMENTS

The inventor noticed that the techniques disclosed in the references noted above in the Background section may not achieve precise, repeatable, reliable, quantitatively accurate, and robust assessments of the wear of steel wire ropes used for example in elevator systems. Indeed, the accuracy of the wear assessment can depend on a number of factors, such as: the resistance or impedance variation due to wear can be very small compared to the rope's resistance or impedance (e.g., the actual wear of the rope usually causes a resistance variation in the range of a fraction of a mΩ); the impedance may change in a significant way due to the occasional proximity of external objects, generating parasitic capacitance and inductance, which may hinder the contribution due to wear in the impedance variation; the rope resistance and impedance may be strongly influenced by the environmental conditions (temperature and hotspot), which may cause a significant variation in the measured resistance or impedance, typically greater than the variation caused by the actual wear of the rope; and typically, the resistance or inductance measurement can be affected by electromagnetic noise and interference, due to the rope's length, conductivity, and proximity to electrical apparatuses.

As an example, a 10 m steel wire rope of 2 mm diameter (as one typically used in elevator belts, commonly called a “strength bearing member”) can have a resistance of about 1Ω. The breaking of just one wire can change the resistance by about 10 to about 30 uΩ. To resolve this quantity, the measurement system must guarantee a very small resolution and a very low noise floor. For longer or thicker ropes, the needed resolution can be even smaller. Moreover, the variation of resistance due to a change in temperature can be 100 times larger than the variation due to wear, making it extremely difficult to determine the wear level.

In view of the above, the inventor has tackled the problem by providing a method for monitoring the wear of steel wire ropes that allows obtaining a more precise and reliable wear assessment than known methods based on a resistance or impedance measurement.

The inventor observed that steel wire ropes have an inhomogeneous structure, being made by a plurality of steel wires, arranged in various strands. In an embodiment of the present disclosure, a steel wire rope can have different shapes and dimensions, including single spiral strands or ropes comprising multiple strands (with or without a rope core). Moreover, as said before, a steel wire rope of an embodiment of the present disclosure can be included in a belt, such as small cords in elevator belts. In some cases, the rope core can be made of a different material than the steel wires. Also, in some applications (e.g. in elevators belts), each wire can be plated with a different metal, such as zinc, that can act as a solid lubricant. Different materials may have a different resistivity, so there is a certain probability that, when measuring the overall rope impedance or resistance with volt-amperometric methods, the current will mostly flow in some materials and not in others. This, in some cases, may reduce the sensitivity of the measurement. Usually, the external surface of wires is more subject to wear (erosion, breaking, etc.), as well as the wire zinc coating. This suggests that to increase the sensitivity in a resistance-based (or, in general, inductance-based) measurement, it can be useful to force the current flow close to the rope's external surface, or, in general, in a predetermined section close to the external surface. A physical phenomenon that can be exploited for this purpose is the skin effect, which can be achieved by using an alternating current (AC) at suitable frequencies. This effect can localize the current closer to the surface as the frequency increases. Because the steel of the rope can be ferromagnetic (e.g., usually with a relative permeability of μr≈100), a suitable skin effect can be achieved at relatively low frequencies (e.g., <50 kHz).

Therefore, according to an embodiment of the present disclosure, the problem above can be solved by a method for monitoring the wear of steel wire ropes that exploits the skin effect associated with the passage of an alternating current inside the rope to evaluate variations on the material structure (over the cross-section) during the rope life. This technique can be well suited for structured and inhomogeneous media, such as a typical steel wire rope, which usually comprises smaller wires. As it will be explained in more detail hereinafter, a method embodiment of the present disclosure can have several additional advantages, such as intrinsically compensating for a temperature variation, to effectively reject electromagnetic noise and to resolve very small changes in the rope resistance (and, consequently, to detect, and localize, very small changes in the structure of the rope). Due to the ferromagnetic properties of the steel wire ropes, a desired depth of the skin effect can be induced at relatively low frequencies (e.g., lower than 50 kHz), which can thus simplify the electronics required by the circuits of the system of the present disclosure.

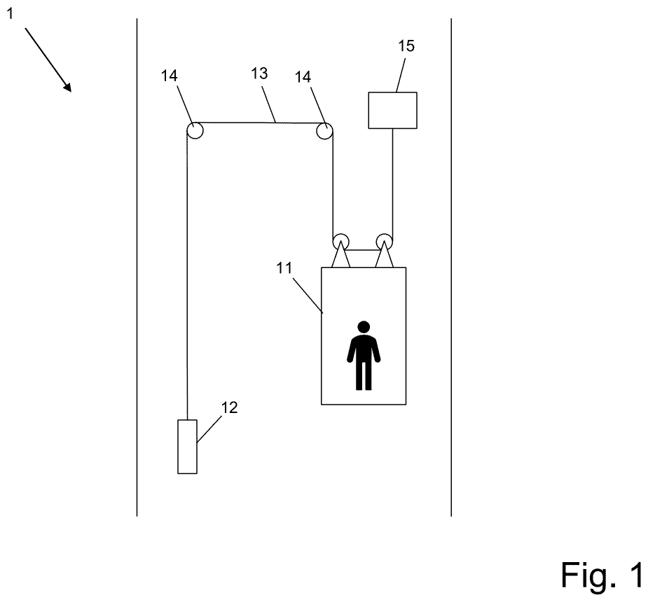

FIG. 1 schematically shows an example elevator system 1. The elevator system includes a car 11 and a counterweight 12, which can be moved by, typically, a motor (not shown in the drawings) and a traction system comprising one or more belts 13 and pulleys 14. The components of a typical elevator system are known, and they will not be further described hereinafter. The elevator system 1, in particular the belt 13, can be connected to a monitoring system 15 suitable for monitoring the wear of the belt's ropes according to an embodiment of the present disclosure.

The belt 13 can include steel wire ropes (which will be indicated with the same reference number 13). Each steel wire rope 13 of the elevator system 1 can include a plurality of steel wires, which may be stranded into cords, and a jacket enclosing the cords. The jacket may be of a polymeric material, for example an elastomeric material.

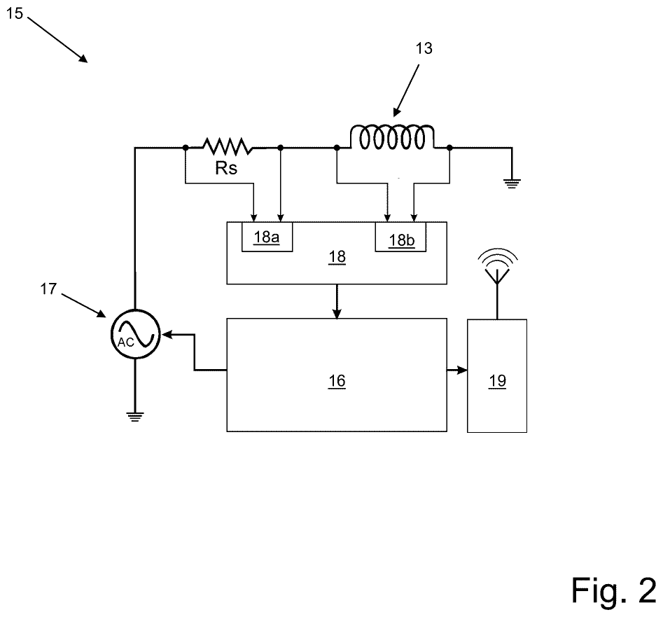

FIG. 2 shows a block schematic of the monitoring system 15 according to an embodiment of the present disclosure. The monitoring system 15 can be electrically connected to the belt, for example at one end of the belt to be monitored. The monitoring system 15 can be configured to assess a wear condition of a steel wire rope 13 of the belt by implementing a monitoring method embodiment of the present disclosure.

The monitoring system 15 can include a processing unit 16, a current generator 17, an acquisition unit 18, and a communication unit 19, any of, any combination of, or all of which may be in plural or may include plural components thereof. The communication unit 19 can include a radio/mobile modem.

The processing unit 16 (or computer) can include a microcontroller, a general purpose processor and/or a DSP (Digital Signal Processor) and/or an FPGA (Field Programmable Gate Arrays), and a memory, for example, and any of, any combination of, or all of which may be in plural or may include plural components thereof. The processing unit 16 can be connected to the current generator 17, to the communication unit 19, and to the acquisition unit 18. The memory of the processing unit 16 can be any suitable non-transitory memory, which can include computer-readable instructions that, when executed by at least one processor of the processing unit 16, can enable the at least one processor to execute and/or control operations/steps of a method embodiment of the present disclosure.

The processing unit 16 can be configured to implement a monitoring method embodiment of the present disclosure as well as data processing operations. A monitoring method embodiment will be described hereinafter. The processing unit 16 can be configured to send the output of the monitoring method to the communication unit 19 as monitoring data messages and/or logs and/or alarms, for example.

The current generator 17 can include a low frequency sinusoidal oscillator, e.g., usually implemented digitally as a Direct Digital Synthesizer (DDS). The current generator 17 can be controlled in amplitude and frequency in ranges of about 0.1 V to about 5 V, and about 1 Hz to about 50 kHz, for example. The amplitude of the voltage may be equal to a few Volts, for example. A direct current (DC) or an alternating current (AC) can be generated starting from the voltage by using an active voltage-to-current converter, or by using a resistor Rs (as schematically shown in FIG. 2), for example. The current amplitude may be about 1 mA to about 10 mA, for example.

The current signal (or the voltage signal across the resistor Rs) can be acquired by the acquisition unit 18 together with the voltage signal across the steel wire rope 13 (which, in the block schematic of FIG. 2, is represented as an inductor). The acquisition unit 18 can include a two-channel synchronous high-resolution Analog to Digital Converter (ADC), featuring, for example, a resolution of about 24 bits and a sampling frequency up to 100 kHz. In such case, a first channel 18a of the acquisition unit 18 can be used to acquire the current signal and a second a channel 18b can be used to acquire the voltage signal.

A monitoring method embodiment of the present disclosure can be performed in a sequence of steps, which can be repeated over time, e.g., at least at two different times, and which can include the following sequence.

At a first time, at each frequency of a set of considered frequencies including a first “base” frequency (in particular, a relatively low frequency or the DC frequency, such as 0 Hz) and at least one second “test” frequency, which can be higher than the first frequency, a respective value of an electrical parameter indicating an opposition of the steel wire rope to the passage of the current at the considered frequency (for example, the impedance or its real part, namely the resistance for example, of the steel wire rope) can be determined.

Also at the first time, on the basis of said values of the electrical parameter, first coefficients can be determined that can be indicative of the skin effect caused by the passage of the current within the considered steel wire rope at the considered test frequencies.

At a second time following the first time, which can be at the same frequencies used in the first time, second values of the electrical parameter can be determined. Also at the second time, on the basis of the second values of the electrical parameter, second coefficients can be determined that can be indicative of the skin effect caused by the passage of the current within the considered steel wire rope at the considered test frequencies.

According to embodiments of the method, the electrical parameter can be the impedance or the resistance of the steel wire rope. In particular, measuring the resistance is advantageous because the reactance can be influenced by the proximity of conductive objects to the steel wire rope that is monitored, which can be an undesired effect that may reduce the sensitivity of the method. As it will be appreciated by the skilled person, when the base frequency is selected to be zero, the electrical parameter that is determined according to these embodiments of the method is the resistance of the steel wire rope.

The set of considered frequencies, as described above, can include a first frequency indicated also as “base frequency”, which can be a fixed low frequency, and a number N of further higher frequencies, indicated also as “test frequencies”, N being an integer equal to or greater than 1. The base frequency may be selected within a range about 0 Hz to about 1 kHz. In particular, the base frequency may be the DC frequency or an AC frequency that is selected within a range from about 1 Hz to about 1 kHz, preferably from 10 Hz to 1 KHz. According to embodiments of the method of the present disclosure, the ratio between any one of the test frequencies and the base frequency can be greater than 1.1.

The method embodiment provides for associating with each test frequency a respective coefficient (the coefficient can be indicated as “skin effect coefficient” or SEC), which can be determined on the basis of two values of the electrical parameter of the steel wire rope: a base value that is determined by generating a current at the base frequency and evaluating the current signal and the voltage signal across the steel wire rope, and a test value that is determined by generating a current at the considered test frequency and evaluating the current signal and the voltage signal across the steel wire rope. According to embodiments of the method, the skin effect coefficient associated with a test frequency is the ratio between said test value and said base value of the electrical parameter.

The skin effect, as the frequency increases, reduces the cross-sectional area of the rope that is available for conducting the current, whose density is larger near the outer surface of the rope and decreases towards the inside of the rope. At a base frequency equal to 0 Hz, no skin effect is present and hence the whole cross-sectional area of the rope is available for conducting the current.

A method embodiment can further provide for comparing the skin effect coefficients computed at a first time (which can be considered as a reference time) by applying a sequence of steps comprising the operations described above with the skin effect coefficients computed at a second time following the reference time during the operation of the steel wire rope, by applying another sequence of steps comprising the operations described above to determine a wear level of the steel wire rope to be monitored, as it will be described herein after. The sequence of steps applied at the reference time will be indicated as reference measurement phase, while the sequence of steps applied at any subsequent time during the operation of the steel wire rope will be indicated simply as measurement phase. The skin effect coefficients computed at the reference time will be indicated as reference skin effect coefficients.

According to embodiments of the present disclosure, the set of considered frequencies may be all pre-defined or selected by an operator before applying a method embodiment for monitoring the steel wire rope at the reference time. The frequencies may thus have pre-defined or selected fixed values. According to these embodiments, the test frequencies may be selected within the range from about 100 Hz to few tens of kHz.

According to these embodiments of the present disclosure, the reference measurement phase may be performed when the steel wire rope 13 is installed in working configuration, for example in the elevator system 1 before the elevator system 1 is put into operation. Alternatively, the reference measurement phase may be performed at a predefined or selected time during the operation of the elevator system 1.

According to these embodiments, the reference measurement phase of the method can provide for:
at each of the considered, fixed, frequencies, generating a respective current signal and determining the value of the considered electrical parameter (for example, the impedance or the resistance of the steel wire rope); and
for each of the test frequencies, determining a respective reference value of the skin effect coefficient, as, e.g., the ratio between the test value and the base value of the electrical parameter.

According to some embodiments of the present disclosure, the base frequency can have a pre-defined or selected fixed value and the test frequencies can be defined, during the reference measurement phase, by specifying a set of fixed values for the reference skin effect coefficients. In other words, each test frequency can be selected in such a way that the associated skin coefficient is equal to a respective fixed value; if the skin effect coefficient is the ratio between the test value and the base value of the electrical parameter, the fixed values may be rational numbers greater than 1 (e.g. 1.5, 2, 2.5, 3, and so on, up to, for example, 10); for example, the first test frequency may be selected in such a way that the associated reference skin effect coefficient is equal to 1.5. It is to be noticed that this skin effect coefficient is necessarily greater than 1 due to the skin effect, which, as the frequency increases, reduces the cross-sectional area of the rope which is available for conducting the current, and so increases the impedance/resistance.

Also in such case, the reference measurement phase may be performed when the steel wire rope 13 is installed in working configuration, for example in the elevator system 1 before the elevator system 1 is put into operation. Alternatively, the reference measurement phase may be performed at a predefined or selected time during the operation of the elevator system 1.

According to some embodiments, the reference measurement phase of steps of a method embodiment can provide for:
defining a set of frequencies including a base frequency and one or more test frequencies (e.g., higher than the base frequency);
at each of the defined frequencies, generating a respective current signal and determining the value of the considered electrical parameter (for example, the impedance or the resistance of the steel wire rope); and
for each of the test frequencies, determining a respective reference value of the skin effect coefficient), as, e.g., the ratio between the test value and the base value of the electrical parameter.

As already described above, a second sequence of steps of the method, which can be referred to as measurement phase can be performed at a time following the reference time, to assess the wear condition of the steel wire rope 13 during the operation of the elevator system 1. The measurement phase can have a duration of a few seconds. The measurement phase may be periodically repeated over time at a predefined or selected repetition rate during the operation of the elevator system 1 (e.g. every few minutes or few hours). Alternatively, the measurement phase may be repeated spot-wise during the operation of the elevator system 1.

At each repetition of the measurement phase, a method embodiment can provide for computing a set of skin effect coefficients at the same frequencies that have been considered during the reference measurement phase and for comparing the computed skin effect coefficients with the reference skin effect coefficients. As it will be described in more detail herein after, such comparison can allow to discriminate between variations affecting the electrical parameter of the steel wire rope caused by temperature (when the skin effect coefficients are “similar” over time, within a predefined or selected tolerance) from variations affecting the electrical parameter caused by structural changes (when the skin effect coefficients change over time) and hence by, possibly, wear. When a structural variation is detected, the values of the electrical parameter can be used to quantitatively evaluate the wear condition in terms of a wear level of the steel wire rope, which in turn may be a function of, or expressed as, for example, a residual load, an expected life, and so on. The outcome of each measurement phase may be provided to a monitoring center or similar, to monitor the wear condition of the steel wire rope and possibly to generate a warning or alarm when such condition becomes critical, for example.

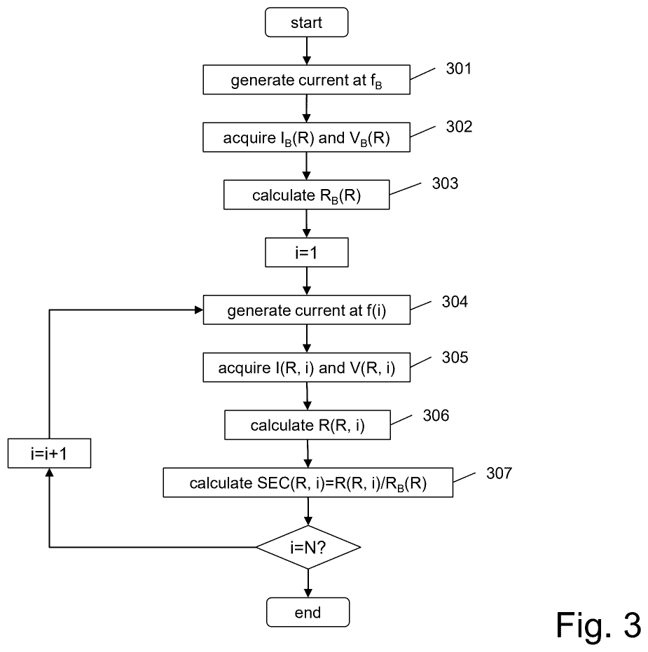

A reference measurement phase will now be described in more detail with reference to the flowchart of FIG. 3 which illustrates example steps of a reference measurement phase according to a method embodiment of the present disclosure. According to some method embodiments, the considered electrical parameter can be the resistance of the steel wire rope, while the skin effect coefficient can be defined as the ratio between the test value and the base value of the resistance, as it will be described herein below. According to some embodiments, the reference measurement phase can include the following steps.

By the current generator 17, a base current can be generated at the base frequency f_{B} (which may be selected within the range between 0 Hz and 1 kHz, for example within the range from 10 Hz to 1 kHz) (step 301).

By the acquisition unit 18, a base current signal I_{B}(R) and a base voltage signal V_{B}(R) across the steel wire rope 13 can be acquired (step 302);

By the processing unit 16, the rope resistance, from the acquired base current and base voltage signals, can be determined (step 303). The resistance value determined at step 303 can be referred to as “base value of resistance” or “base resistance” and indicated as R_{B}(R);

By the current generator 17, a current at the first test frequency f(1) higher than the base frequency fB (e.g. >10 kHz) can be generated (step 304).

By the acquisition unit 18, a first current signal I(R, 1) and a first voltage signal V(R, 1) across the steel wire rope 13 can be acquired (step 305);

By the processing unit 16, the rope resistance can be determined, which can be referred to as “first test value of resistance” or “first test resistance” and indicated as R(R, 1) (step 306);

By the processing unit 16, a first reference skin effect coefficient SEC(R, 1) can be calculated as a ratio between the first test resistance R(R, 1) and the base resistance R_{B}(R) (step 307).

The order of steps described above is not necessarily limited to those shown by way of example. Indeed, steps 301-303 and steps 304-306 may be performed in the order described herein above but also in a reverse order, namely steps 304-306 may be performed before steps 301-303.

At steps 302 and 305, the acquisition of the current signal and the voltage signal may be performed by acquiring samples of the two signals over a time interval of about few seconds (e.g. from 1 s to 10 s), for example. The acquired samples may be stored in memory of the processing unit 16 and processed later to determine the rope resistance, or they may be processed in real-time to reduce the memory storage requirement.

Steps 304-307 may be repeated a number N−1 of times (if N is an integer number greater than 1) by generating an i-th current at an i-th test frequency f(i) (i=2, . . . , N) and calculating an i-th reference skin effect coefficient SEC(R, i) as the ratio between the i-th test resistance R(L, i) and the base resistance R_{B}(R). At each i-th repetition, the considered test frequency can be higher than the test frequency at the preceding (i−1)-th repetition. As the frequency increases, also the reference skin effect coefficient increases due to the skin effect already described above.

As described above, the first test frequency f(1) may be a fixed frequency. According to some embodiments, each possible test frequency f(i), i=1, . . . , N, can be a fixed frequency that is pre-defined or selected by the operator.

According to some embodiments, the first test frequency f(1) may be selected in such a way that the ratio between the first test resistance R(R, 1) and the base resistance R_{B}(R) is equal to a first fixed value (namely, a rational number greater than 1), for example equal to 1.5. According to some embodiments of the present disclosure, each i-th test frequency may be selected in such a way that the respective ratio between the i-th test resistance R(R, i) and the base resistance R_{B}(R) is equal to an i-th fixed value. At each i-th test frequency, the reference skin effect coefficient SEC(L, i) can be greater than the reference skin effect coefficient SEC(L, i−1) associated with the (i−1)-th test frequency. For example, considering a number N=5 of test frequencies, five frequencies may be selected in such a way that the corresponding reference skin effect coefficients assume the five following fixed values: 1.5, 2, 2.5, 3, 3.5.

According to some embodiments, the definition of the first test frequency f(1) can be performed by implementing a recursive computation of the corresponding reference skin effect coefficient (namely, implementing recursively steps 304-307) starting from an initial fixed value of the first test frequency and then possibly stepping up the frequency value until the computed reference skin effect coefficient is equal to the desired fixed value, e.g. 1.5. The same procedure may be performed for each test frequency to be considered.

According to some embodiments of the method of the present disclosure, at the end of the reference measurement phase, the values of the base and test frequencies f_{B}, f(1) and f(i), i=2, . . . , N, and the corresponding reference skin effect coefficients SEC(R, 1) and, possibly, SEC(R, i), i=2, . . . , N may be stored in memory of the processing unit 16. According to some embodiments, the reference skin effect coefficients SEC(R, 1) may be computed at a different time following the reference time, for example during a subsequent measurement phase. In such case, at the end of the reference measurement phase, memory of the processing unit 16 may store the values of the frequencies, the test resistances R(R, i), i=1, . . . , N, and the base resistance R_{B}(R).

Hence, during the reference measurement phase, a base frequency can be applied at a relatively low frequency (for example, from 10 Hz to 1 kHz), then other higher frequencies (the test frequencies referred to above) can be applied. This same set of frequencies can be then used during the measurement phase, when the variability of the skin effect coefficients is checked, as it will be described herein below.

The frequencies of the current generator 17 may range from a very low value to some tens of kHz. In this frequency range, due to the ferromagnetic properties of the steel wire rope, the skin depth varies between nearly the whole radius of the rope (which means that there is almost no skin effect) to less than about 100 μm.

The generated current can be applied to the steel wire rope and then the current and the voltage across the steel wire rope can be acquired to determine the resistance. This implies that the steel wire rope is accessed by the two ends. The return path of the current may be made through an already present metallic structure or a return wire. If the belt includes two or more steel wire ropes, the measurement can be done at the near end by connecting in series two ropes at the far end. In such case, the measurement can determine the average wear level of the two ropes.

At steps 303 and 306 of the reference measurement phase described above, the processing unit 16 preferably determines the rope impedance and, in particular, the rope resistance. When AC frequencies are considered, this calculation can be performed by implementing a procedure that is similar to the one performed by a known lock-in amplifier (also indicated as signal projection technique): the voltage signal V(t) is multiplied by the current signal and by its 90° phase-shifted version; and then both the quantities are integrated over the measurement interval. This operation can give the projection of the voltage signal on the in-phase and in-quadrature component of the current signal (which are indicated as Ii(t) and Iq(t), respectively). Starting from these two components, the resistance and reactance may be calculated. The projection operation is equivalent to a very narrow band-pass filter, and it can allow to reject most of the environmental noise from the measures and to increase the precision and sensitivity thanks to the integration. To increase the accuracy, the integration interval (i.e. the measurement interval) may be extended over a longer period.

The projection Vi of the voltage on the in-phase current signal Ii(t) and the projection Vq of the voltage on the quadrature current signal Iq(t) can be calculated as follows:

$$Vi = {\int }_{o}^{T} \frac{Ii ( t ) V ( t )}{‖ Ii ‖}$$

$$Vq = {\int }_{o}^{T} \frac{Iq ( t ) V ( t )}{‖ Iq ‖} dt$$

where, for x=i, q:

$$‖ x ‖ = \sqrt{\frac{1}{T} {\int }_{0}^{T} {Ix ( t )}^{2} dt}$$

is the energy of the current signal (in-phase component and in-quadrature component, respectively) and T is the selected integration interval (usually comprising several AC cycles, up to few seconds).

The impedance, resistance and reactance of the rope can be calculated as follows:

$$Z = \frac{\vert V \vert}{\vert I \vert} {e}^{- j ( ω t + θ )} = R + jX$$

where Z is the rope impedance, R is the rope resistance and X is the rope reactance and where:

$$\vert V \vert = \sqrt{{Vi}^{2} + {Vq}^{2}}$$

$$\vert I \vert = \sqrt{{Ii}^{2} + {Iq}^{2}}$$

$$θ = arctan ( \frac{Vq}{Vi} )$$

$$\vert Z \vert = \frac{\vert V \vert}{\vert I \vert}$$

$$R = \vert Z \vert \cdot cos ( θ )$$

$$X = \vert Z \vert \cdot sin ( θ ) .$$

The current Ii (in-phase component), according to the scheme of FIG. 2, can be calculated as the voltage across the Rs resistor divided by the value of Rs. The current Iq (quadrature component) can be derived from the in-phase component Ii by applying a hardware or software 90° phase shifter filter (not shown in FIG. 2).

When the DC frequency is considered as base frequency, the base resistance may be calculated from the generated current signal and the voltage signal across the steel wire rope (which are constant signals) by applying Ohm's law.

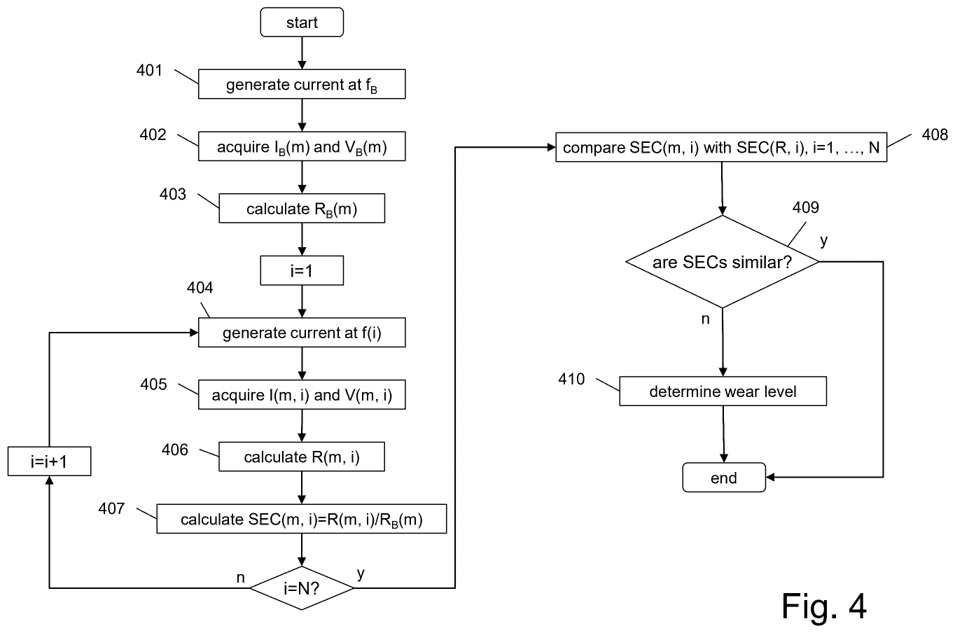

FIG. 4 illustrates in more detail the steps of the measurement phase according to a method embodiment of the present disclosure. The measurement phase can be started by setting and activating the current generator 17 to generate currents at the frequencies that have been considered during the reference measurement phase.

According to some method embodiments, in conformity with what has been described above for the reference measurement phase, the electrical parameter can be the resistance of the steel wire rope, while the skin effect coefficient can be defined as the ratio between the test and base values of resistance, as it will be described herein below. According to some embodiments, the measurement phase can include the following steps.

By the current generator 17, a reference current at the base frequency f_{B} can be generated (step 401).

By the acquisition unit 18, a base current signal I_{B}(m) and voltage signal V_{B}(m) across the steel wire rope 13 can be acquired (step 402);

By the processing unit 16, the base resistance R_{B}(m) can be determined (step 403);

By the current generator 17, a current at the first test frequency f(1) can be generated (step 404);

By the acquisition unit 18, a first current signal I(m, 1) and a first voltage signal V(m, 1) across the steel wire rope 13 can be acquired (step 405);

By the processing unit 16, the first test resistance indicated as R(m, 1) can be determined (step 406);

By the processing unit 16, a first skin effect coefficient SEC(m, 1) as the ratio between the first test resistance R(m, 1) and the base resistance RR(m) can be calculated (step 406).

The order of steps described above is not necessarily limited to those shown by way of example. Indeed, steps 401-403 and steps 404-606 may be performed in the order described herein above but also in reverse order, namely steps 304-306 may be performed before steps 401-403, for example.

As already mentioned above, the acquisition of the current signal and the voltage signal may be performed by acquiring samples of the two signals over a time interval of about few seconds (e.g. from 1 s to 10 s), for example. The acquired samples may be stored in memory of the processing unit 16 and processed later to determine the rope resistance or they may be processed in real-time to reduce the memory storage requirement. At steps 403 and 406 of the measurement phase described above, the rope resistance can be computed by the processing unit 16 as already described above with reference to steps 303 and 306 of the flowchart of FIG. 3.

Steps 404 to 407 are preferably repeated a number N−1 of times, N being the number of test frequencies.

At the end of the measurement phase, the skin effect coefficients SEC(m, 1) and, possibly, SEC(m, i), i=2, . . . , N can be stored in memory of the processing unit 16.

Then, the method embodiment preferably includes step 408 at which the skin effect coefficients SEC(m, i), i=1, . . . , N computed at the end of the measurement phase are compared, by the processing unit 16, with the reference skin effect coefficients SEC(R, i), i=1, . . . , N. In particular, the first skin effect coefficient SEC(m, 1) computed at the first test frequency f(1) can be compared with the reference skin effect coefficient SEC(R, 1) computed at the same first test frequency f(1), and the same operation can be repeated for the skin effect coefficients computed at each test frequency f(i), i=2, . . . , N. The operation of comparing the skin effect coefficients is preferably performed by the processing unit 16 by computing a difference between each pair of skin effect coefficients as follows:

$$Δ C ( i ) = \vert SEC ( m , i ) - SEC ( R , i ) \vert , i = 1 , … , N$$

where the operator |⋅| indicates the absolute value. This difference will be indicated as “variation coefficient” ΔC(i), i=1, . . . , N).

At step 409, the processing unit 16 preferably evaluates whether for each considered test frequency f(i), i=1, . . . , N, the skin effect coefficient SEC(m, i) computed at the end of the measurement phase is similar to the corresponding reference skin effect coefficient SEC(R, i). In particular, the similarity between each pair of skin effect coefficients SEC(m, i) and SEC(R, i), i=1, . . . , N, is preferably evaluated by checking the value of the variation coefficient ΔC(i).

The variation coefficient ΔC(i), i=1, . . . , N may be indicative of a variation within the structure of the steel wire rope due to wear. Indeed, wear may cause an erosion of the surfaces of the wires and/or the breaking of one or more wires, which can affect the value of the measured resistance. The value of the measured resistance may be affected by the structure variation by a different amount when different frequencies are considered, due to the fact that the skin depth varies with frequency. A variation in the temperature changes the measured resistance of the steel wire rope. However, if the skin effect coefficient is defined as the ratio of the measured resistances as described above, the temperature variation does not change the ratio as it affects both the values of the resistance by the same factor.

If, at step 409, all the variation coefficients ΔC(i), i=1, . . . , N are determined to be substantially equal to zero (namely, equal to zero unless a predefined or selected tolerance ε, which may be equal to 1%), the processing unit 16 preferably determines that the structure of the steel wire rope has not changed over the time interval between the reference measurement phase and the following measurement phase. In such case, at the end of step 409, it can be determined that the wear condition of the steel wire rope is acceptable.

If, at step 409, at least one of the variation coefficients ΔC(i), i=1, . . . , N is determined to be different from zero, unless a predefined or selected tolerance ε, the processing unit 16 preferably detects a variation within the structure of the steel wire rope that determines a variation of the value of the electrical parameter that has been measured (namely, the resistance, according to the embodiment described so far). In particular, a variation within the structure of the steel wire rope at frequency f(i) can be detected by the processing unit if:

ΔC(i)>ε,

where ε may be equal to about 1%, for example. In such case, all the variation coefficients ΔC(i), i=1, . . . , N can be further processed by the processing unit 16 and they can be associated with a wear level indicative of a wear condition of the steel wire rope (step 410). The wear level can be the output of a monitoring method embodiment. The wear level may be provided as indicating a residual load of the steel wire rope and/or an expected life. According to some method embodiments of the present disclosure, the wear level can indicate the residual load of the steel wire rope.

In particular, determining the wear level of the steel wire rope is preferably performed by the processing unit 16 by implementing a mapping operation at step 410, for example. The mapping operation can be configured to associate the set of variation coefficients ΔC(i), i=1, . . . , N with the wear level. The mapping operation may be implemented by using a mapping function, which can be implemented as an analytic function and/or a look-up table (map) and/or a machine learning algorithm such as a neural network, in particular a feed-forward neural network, to correlate the values of the variation coefficients with wear levels. The mapping function may be determined off-line by using experimental data on the steel wire rope. For example, in case a feed-forward neural network is used, the weights of the neural network may be determined off-line based on experimental data. Different sets of neural network weights or different maps can be defined for different types of steel wire rope and they may be stored in memory of the processing unit 16, to be read online immediately after the measurement phase, for example.

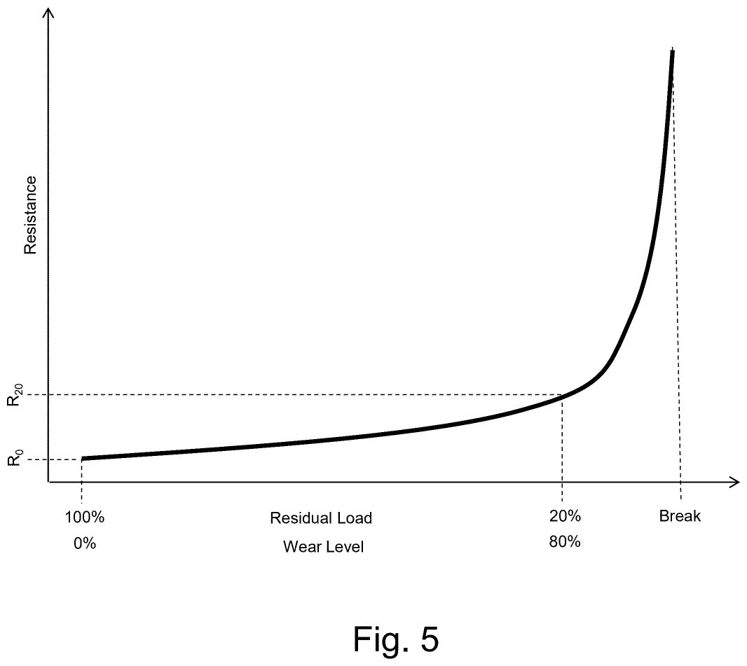

FIG. 5 shows an example graph based on experimental data to put in relation the resistance of an example steel wire rope with the residual load (a wear level is also indicated, which is substantially inversely proportional to the residual load). The graph of FIG. 5 also shows a first value R0 of resistance corresponding to a residual load of about 100% and a second value R20 of resistance corresponding to a residual load of about 20%. Moreover, the abrupt increase in the resistance can correspond to a condition in which there is a break.

In practice, fatigue and aging tests can be typically carried out off-line on a given type of steel wire rope over a number of cycles until the steel wire rope breaks. By carrying out measurements during these aging cycles (the effect of aging on the mechanical degradation of the rope is well known), it is possible to extrapolate a relationship between the skin effect coefficients at the considered test frequencies (wherein each skin effect coefficient is determined as the ratio between the test value of resistance measured at the end of the aging cycle and a base value of resistance, as described above) and the residual load. The extrapolated relationship may be “learned” by a neural network and/or it may be approximated by a look-up table.

Once the wear level is determined, this data can be logged, communicated, and/or used to generate alarms (by comparing the wear level against a predefined or selected threshold). For example, by providing the wear level in terms of a residual load, an alarm may be raised if, at the output of the mapping function, the residual load is determined to be below 80%. The output of the monitoring method may be sent by the processing unit 16 to the communication unit 19, which may employ the radio/mobile modem to transmit the data to a remote and/or centralized monitoring platform, where the status and alarms can be observed.

As already described above, the proposed method embodiment advantageously can exploit the skin effect by measuring the resistance of different circular areas (each extending from the outer surface to the respective skin depth) of the cross section of the steel wire rope when different frequencies are considered. By comparing the skin effect coefficient at a given frequency over time (which is indicative of the resistance associated with a specific circular area of the cross-section of the steel wire rope), it can be possible to detect a structural variation located within the specific circular area which led to the variation of the skin effect coefficient value. Using an embodiment of the present disclosure, the sensitivity to variations within the structure of the steel wire rope can be thus significantly improved.

Advantageously, a method embodiment of the present disclosure is relatively simple to implement, but very precise and repeatable. In particular, the current and voltage level can be very low, respectively in the range from 1 mA to 10 mA and from 0.1 V to 5 V. The measurement time can be in the order of few seconds and the measurement phase can be repeated every few minutes or few hours. This advantageously avoids inducing unwanted damage to the rope (e.g. by heating, by galvanic corrosion, etc). The frequencies that are used can be very low, at most in the order of few tens of kHz (the maximum frequency may be 50 kHz). This can limit unwanted electromagnetic emission and allow using simple and very high-resolution electronics (24 or more) that are not easily available for higher frequencies (such as the one used by known methods based on an impedance measurement). Because the resistance/impedance variations due to wear are very small compared to the normal rope resistance/impedance, it is important to achieve high resolutions and very low noise data. In fact, the expected variations are in the order of few tens of μΩ (over a rope resistance in the order of 1-10Ω) in a first stage of the wearing process. A method embodiment of the present disclosure, as mentioned, advantageously can allow achieving such high resolution by exploiting the skin effect and also by using the signal projection technique for calculating the resistance, as described above.

What is claimed is:

1. A method for monitoring wear of a steel wire rope, the method comprising:
at a first test, generating a first current at a base frequency and determining a first base value of an electrical parameter of the steel wire rope indicating an opposition of the steel wire rope to passage of the first current, the steel wire rope comprising a plurality of steel wires;
at the first test, generating a second current at a test frequency higher than the base frequency and determining a first test value of the electrical parameter of the steel wire rope;
at a second test following the first test, generating a third current at the base frequency and determining a second base value of the electrical parameter of the steel wire rope;
at the second test, generating a fourth current at the test frequency and determining a second test value of the electrical parameter of the steel wire rope;
determining a first coefficient based on the first base value and the first test value of the electrical parameter of the steel wire rope;
determining a second coefficient based on the second base value and the second test value of the electrical parameter of the steel wire rope; and
determining, using the first coefficient and the second coefficient, a wear level of the steel wire rope.

2. The method of claim 1, wherein the electrical parameter is an impedance or a resistance of the steel wire rope.

3. The method of claim 2, wherein each of the determining of the first base value, the determining of the first test value, the determining of the second base value, and the determining of the second test value of the electrical parameter comprises:
acquiring a voltage across the steel wire rope;
obtaining an in-phase component of the voltage by multiplying the voltage by the respective current and integrating over a measurement interval;
obtaining a quadrature component of the voltage by multiplying the voltage by a 90 degrees phase-shifted version of the respective current and integrating over the measurement interval;
obtaining a voltage amplitude of the voltage based on the in-phase component and the quadrature component of the voltage; and
computing the impedance or resistance as a ratio between the voltage amplitude of the voltage and a current amplitude of the respective current.

4. The method of claim 1, wherein the first coefficient is a first ratio between the first test value and the first base value of the electrical parameter, and wherein the second coefficient is a second ratio between the second test value and the second base value of the electrical parameter.

5. The method of claim 4, wherein the base frequency is a fixed frequency and the test frequency is selected such that the first ratio or the second ratio has a fixed value.

6. The method of claim 1, wherein the method further comprises:
providing a set of test frequencies comprising a number, N, of the test frequencies, wherein N is an integer greater than 1, and wherein each of the set of the test frequencies is higher than the base frequency;
at the first test, for each of the set of the test frequencies, performing the generating of the second current at the test frequency higher than the base frequency and determining the first test value of the electrical parameter of the steel wire rope;
at the second test, for each of the set of the test frequencies, performing the generating of the fourth current at the test frequency and determining the second test value of the electrical parameter of the steel wire rope;
determining, for each of the set of the test frequencies, a respective first coefficient based on the first base value and a respective first test value of the electrical parameter of the steel wire rope and a respective second coefficient based on the second base value and a respective second test value of the electrical parameter of the steel wire rope; and
determining, using the first coefficients and the second coefficients, the wear level of the steel wire rope.

7. The method of claim 1, wherein the determining, using the first coefficient and the second coefficient, the wear level of the steel wire rope, comprises computing a difference between the first coefficient and the second coefficient and, based on the difference, determining whether a variation within a structure of the steel wire rope has occurred between the first test and the second test.

8. The method of claim 7, wherein the determining of the wear level of the steel wire rope comprises mapping the difference to the wear level by use of an analytic function, a look-up table, or a machine learning algorithm.

9. The method of claim 1, wherein the wear level indicates a residual load of the steel wire rope.

10. The method of claim 1, wherein the base frequency is selected between 10 Hz and 1 kHz.

11. A wear monitoring system for monitoring wear of a steel wire rope, the wear monitoring system comprising:
a current generator, wherein the current generator is configured to generate a first current at a base frequency and to generate a second current at a test frequency higher than the base frequency;
at least one processor; and
a non-transitory memory storing computer-readable instructions that, when executed by the at least one processor, enable the at least one processor to:
determine a base value of an electrical parameter of the steel wire rope indicating an opposition of the steel wire rope to passage of the first current at the base frequency,
determine a test value of the electrical parameter indicating an opposition of the steel wire rope to passage of the second current at the test frequency,
determine a coefficient based on the base value and the test value of the electrical parameter of the steel wire rope, and
determine a wear level of the steel wire rope using the coefficient as determined at a first test and the coefficient as determined at a second test following the first test.

12. An elevator system comprising the steel wire rope and the wear monitoring system of claim 11.

13. A method for monitoring wear of a steel wire rope, the method comprising:
performing a first test for monitoring wear of the steel wire rope using a base frequency and a set of test frequencies resulting in a first set of skin effect coefficients;
performing a second test for monitoring wear of the steel wire rope using the base frequency and the set of test frequencies resulting in a second set of skin effect coefficients, wherein the second test is performed at a time after the first test; and
comparing the second set of skin effect coefficients with the first set of skin effect coefficients to determine a wear level of the steel wire rope based on a difference between the second set of skin effect coefficients and the first set of skin effect coefficients.

14. The method of claim 13, wherein each of the first test and the second test comprises:
generating a base current in the steel wire rope at the base frequency and determining a base value of an electrical parameter of the steel wire rope indicating an opposition of the steel wire rope to passage of the base current; and
generating a test current at each of the set of the test frequencies, wherein each of the set of the test frequencies is higher than the base frequency, and determining a set of test values of the electrical parameter of the steel wire rope.

15. The method of claim 14, wherein the electrical parameter is an impedance or a resistance of the steel wire rope.

16. The method of claim 15, wherein each of the skin effect coefficients is defined as a test impedance or a test resistance of the steel wire rope at a given test frequency divided by a base impedance or a base resistance of the steel wire rope at the base frequency.

17. The method of claim 13, the determining of the wear level of the steel wire rope comprises mapping the difference between the second set of skin effect coefficients and the first set of skin effect coefficients to the wear level by use of an analytic function, a look-up table, or a machine learning algorithm.

18. The method of claim 13, wherein the wear level indicates a residual load of the steel wire rope.

19. The method of claim 13, wherein the base frequency is selected between 10 Hz and 1 kHz.

20. The method of claim 13, wherein the method further comprises providing the set of test frequencies comprising a number, N, of the test frequencies, wherein N is an integer greater than 1, wherein each of the test frequencies in the set of test frequencies differs from each other.
